(19) United States
(12) Patent Application Publication
(10) Pub. No.: US 2017/0220232 A1
(43) Pub. Date: Aug. 3, 2017

(54) SMART SLIDES IN A PRESENTATION PROGRAM

(71) Applicant: Microsoft Technology Licensing, LLC, Redmond, WA (US)

(72) Inventors: Michael Jay Gilmore, Bothell, WA (US); Kerry Young, San Jose, CA (US); Lei Shi, Cupertino, CA (US); Alexandre Gueniot, Mountain View, CA (US); Derek Martin Johnson, Mountain View, CA (US); Jing Zhao, Cupertino, CA (US); Charles Cummins, Seattle, WA (US); Aviral Ajit, Redmond, WA (US); Paul Scuderi, Redmond, WA (US)

(21) Appl. No.: 15/332,114

(22) Filed: Oct. 24, 2016

Related U.S. Application Data
(60) Provisional application No. 62/288,125, filed on Jan. 28, 2016.

(51) Int. Cl. G06F 3/0484; G06F 9/44; G06F 3/16

(52) U.S. Cl. CPC G06F 3/04845; G06F 3/167; G06F 9/4443; G06F 3/04883

(57) ABSTRACT

Technology is disclosed herein that enhances the user experience with presentation programs and the operational aspects of such programs. In an implementation, a presentation program includes a hierarchy of parent slides and child slides in a collection of slides. Navigating from a parent slide to a child slide triggers a contextual zoom-in transition into the child slide. Navigating back to the parent slide from the child slide triggers a contextual zoom-out transition to the parent slide. Other non-limiting examples describe smart slide functionality of an exemplary presentation program. A smart slide is a slide of a slide deck that comprises one or more slide links, which provide an active link to another slide of the slide deck.

### CROSS-REFERENCE TO RELATED APPLICATION(S)

This application is a Non-Provisional patent application of, and claims priority to, U.S. Provisional Patent Application No. 62/288,125, filed Jan. 28, 2016, entitled “SMART SLIDES IN A PRESENTATION PROGRAM,” which application is incorporated herein by reference in its entirety.

### TECHNICAL BACKGROUND

Presentation programs are software applications that allow end-users to create and view slide-based presentations. PowerPoint® from Microsoft®, Google® Slides, and Keynote® from Apple® are several examples of presentation programs that follow the slide-show model for presentations. Users utilize presentation programs to create slide-based presentations. However, it is difficult for users to organize series of slides and/or content for slide-based presentations. Presently, users have to manually organize slides in an order that they desire. Further, during presentation of a slide show, navigation between slides is restricted by an order in which the slides are organized.

As such, examples of the present application are directed to the general technical environment related to improving organization and navigation of presentation programs, among other examples.

### SUMMARY

Technology is disclosed herein that enhances the user experience with presentation programs and the operational aspects of such programs. In an implementation, a presentation program includes a collection of slides that may comprise sections of slides. A section of slides may comprise one or more slides. As an example, a section that comprises multiple slides may include slides having a parent/child relationship. For instance, a first slide of a section may be a parent slide and the subsequent slides of the section may be considered child slides that are associated with the parent slide. Navigating from a parent slide to a child slide triggers a contextual zoom-in transition into the child slide. Navigating back to the parent slide from the child slide triggers a contextual zoom-out transition to the parent slide.

In some examples, a user may navigate to a section of slides through selection of a slide link. A slide link provides direct access to another slide whether that slide is in the same slide deck or another slide deck. A slide that comprises one or more slide links is a smart slide. A slide link may provide a relationship between a smart slide and another slide (or section of slides). Similar to the parent/child relationship described above with respect to a section of slides, a smart slide may be a parent slide of another slide (child slide) that is linked to the smart slide through a slide link. Linkage between a smart slide and a child slide may be utilized for improving navigation to and from a smart slide. Navigation to and from a smart slide may comprise a contextual zoom transition (e.g. zoom-in or zoom-out). For instance, a contextual zoom transition may factor in features (e.g. placement, scale, orientation, etc.) associated with a slide link when transitioning between a smart slide and another slide.

In other non-limiting examples, the present disclosure describes smart slide functionality of an exemplary presentation program. As an example, a slide link presented within a slide is selected during a slide show presentation mode. Based on the selection of the slide link, an exemplary presentation program may navigate to a first slide (e.g. parent slide) of a section of slides that is associated with the selected slide link. The navigating may comprise non-linear navigation of slides out of an original slide order of the slide deck. A section of slides may comprise the parent slide and one or more child slides that are associated with the parent slide. Input may be received requesting navigation to the one or more child slides. A presentation program may navigate to the one or more child slides based on the received input. The presentation program may automatically return back to the parent slide based upon navigational completion of the one or more child slides of the section.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a block diagram illustrating an example of a computing device with which aspects of the present disclosure may be practiced.

FIGS. 2A and 2B are simplified block diagrams of a mobile computing device with which aspects of the present disclosure may be practiced.

FIG. 3 is a simplified block diagram of a distributed computing system in which aspects of the present disclosure may be practiced.

FIG. 4A is an exemplary method related to creation of an exemplary section of slides, with which aspects of the present disclosure may be practiced.

FIG. 4B is an exemplary method related to rendering an exemplary slide link, with which aspects of the present disclosure may be practiced.

FIG. 4C is an exemplary method related to execution of an exemplary presentation program, with which aspects of the present disclosure may be practiced.

FIGS. 5A-5C provide exemplary user interface views for an exemplary presentation program, with which aspects of the present disclosure may be practiced.

### DETAILED DESCRIPTION

Technology is disclosed herein for enhancing the digital presentation creation experience. In an implementation, a smart slide concept is proposed in a presentation program that provides a new way to structure an exemplary slide deck of a presentation program. A smart slide is a slide of a slide deck that comprises one or more slide links, which provide an active link to another slide of the slide deck. A slide deck is a group of slides that is used for a slide show presentation. More interactive stories, improved navigation, and contextual transitions are possible with the smart slide. An exemplary presentation program may be configured to provide features for creation and management of an exemplary smart slide and an exemplary slide link, for example, through an improved user interface of the presentation program.

A smart slide may be a component of an exemplary section of slides. A section of slides is a grouping of one or more slides of a slide deck, for example, in a parent and child relationship. A section of slides may comprise a parent slide and one or more child slides. Slide links can be created for individual slides or sections of slides. Slide links may be used to associate child slides with multiple parent slides. In one example, an exemplary slide link may be a slide preview of a first slide of section (e.g. parent slide). A slide preview may be a pictorial representation of a slide but may comprise additional types of content including but not limited to rich text format, audio content, video content, hyperlinks, etc. In at least one example, a presentation program may be configured to dynamically update exemplary slide links when content of a slide (associated with the slide link) is modified.

When a slide link is associated with a section of slides, rendering of the slide link may link a slide to a parent slide of the section. An exemplary slide link can be positioned within a slide deck to provide direct access to a section of slides. In alternative examples, a slide link may pertain to a specific child slide of a section. Navigational control provided by an exemplary presentation program may vary depending on the type of slide link created.

In a brief example, selection of a slide link (of an exemplary smart slide) may cause the presentation program to execute a contextual zoom transition between the smart slide and a linked slide. A contextual zoom provides a view of content for the slide that is next to be viewed in a manner that relates to the slide that is currently being viewed. In executing a contextual zoom transition, the presentation program may seamlessly move to another slide so a user does not feel like the presentation program is moving to another slide. As described below, contextual zoom transitions may comprise zoom-in transitions and zoom-out transitions.

In one example, the presentation program may be configured to automatically re-navigate a slide deck to a parent slide associated with a slide link. In another example, when viewing of a linked slide (or section of slides) is completed, a presentation program can be configured to return control of the slide deck back to the smart slide from which the slide link originated. In an example where a slide link is provided to a section of slides, completion of a last slide of a section may trigger an automatic return back to an exemplary smart slide. This can provide enhanced navigational control when viewing a slide deck (e.g. in a slide show presentation mode) as well as improving an overall user experience when using a presentation program, among other examples.

Accordingly, the present disclosure provides a plurality of technical advantages including but not limited to: improved functionality for a presentation program including user interface elements for creation and management of an smart slide and/or slide links, improved organization of content of a slide deck including an ability to group slides and create smart slides and slide links, more efficient operation of processing devices (e.g., saving computing cycles/computing resources) when creating and/or viewing a slide deck and improved user interaction with an exemplary presentation program including improved navigational control when viewing a slide show presentation mode, among other examples.

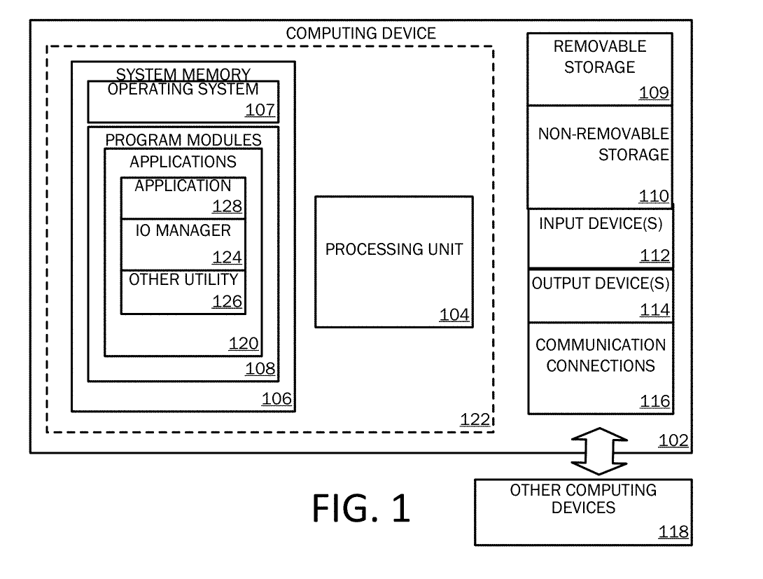

FIGS. 1-3 and the associated descriptions provide a discussion of a variety of operating environments in which examples of the invention may be practiced. However, the devices and systems illustrated and discussed with respect to FIGS. 1-3 are for purposes of example and illustration and are not limiting of a vast number of computing device configurations that may be utilized for practicing examples of the invention, described herein.

FIG. 1 is a block diagram illustrating physical components of a computing device 102, for example a mobile processing device, with which examples of the present disclosure may be practiced. Among other examples, computing device 102 may be an exemplary computing device configured for execution of an exemplary presentation program as described herein. In a basic configuration, the computing device 102 may include at least one processing unit 104 and a system memory 106. Depending on the configuration and type of computing device, the system memory 106 may comprise, but is not limited to, volatile storage (e.g., random access memory), non-volatile storage (e.g., read-only memory), flash memory, or any combination of such memories. The system memory 106 may include an operating system 107 and one or more program modules 108 suitable for running software programs/modules 120 such as IO manager 124, other utility 126 and application 128. As examples, system memory 106 may store instructions for execution. Other examples of system memory 106 may store data associated with applications. The operating system 107, for example, may be suitable for controlling the operation of the computing device 102. Furthermore, examples of the invention may be practiced in conjunction with a graphics library, other operating systems, or any other application program and is not limited to any particular application or system. This basic configuration is illustrated in FIG. 1 by those components within a dashed line 122. The computing device 102 may have additional features or functionality. For example, the computing device 102 may also include additional data storage devices (removable and/or non-removable) such as, for example, magnetic disks, optical disks, or tape. Such additional storage is illustrated in FIG. 1 by a removable storage device 109 and a non-removable storage device 110.

As stated above, a number of program modules and data files may be stored in the system memory 106. While executing on the processing unit 104, program modules 108 (e.g., Input/Output (I/O) manager 124, other utility 126 and application 128) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 102 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 102 may also have one or more input device(s) 112 such as a keyboard, a mouse, a pen, a sound input device, a device for voice input/recognition, a touch input device, etc. The output device(s) 114 such as a display, speakers, a printer, etc. may also be included. The aforementioned devices are examples and others may be used. The computing device 104 may include one or more communication connections 116 allowing communications with other computing devices 118. Examples of suitable communication connections 116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 106, the removable storage device 109, and the non-removable storage device 110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 102. Any such computer storage media may be part of the computing device 102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

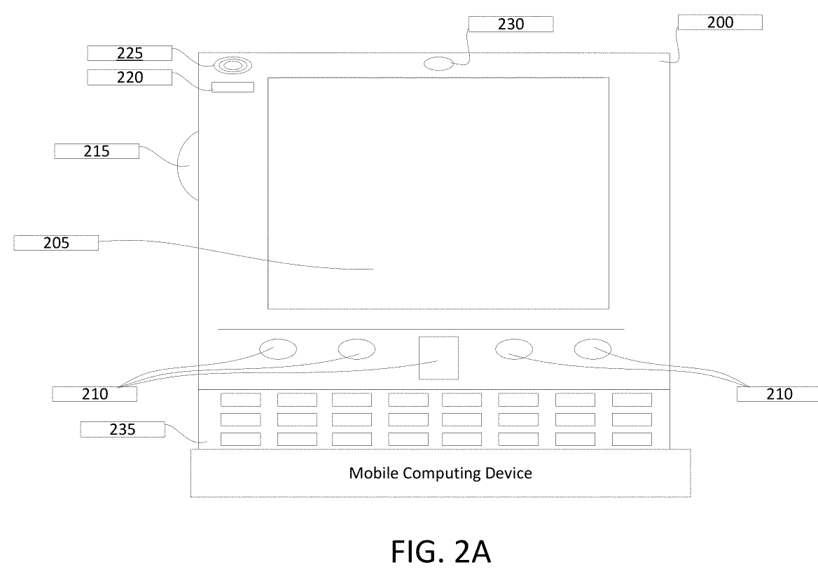

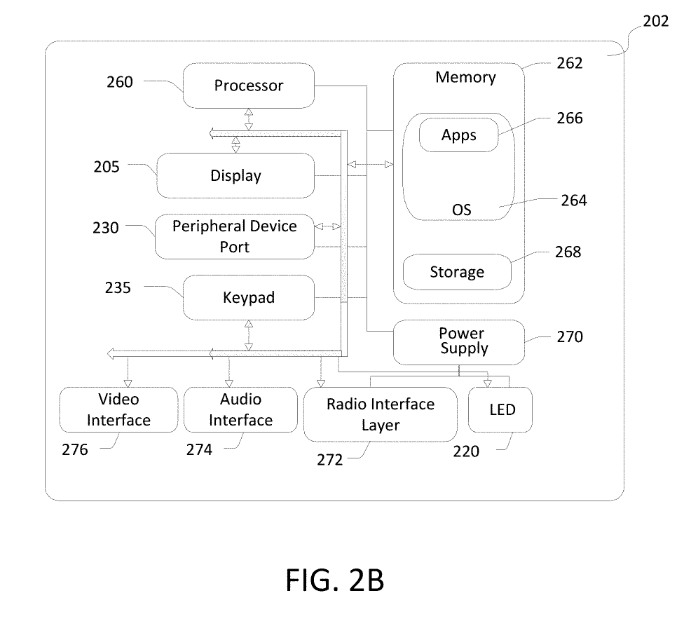

FIGS. 2A and 2B illustrate a mobile computing device 200, for example, a mobile telephone, a smart phone, a personal data assistant, a tablet personal computer, a phablet, a slate, a laptop computer, and the like, with which examples of the invention may be practiced. Mobile computing device 200 may be an exemplary computing device configured for execution of an exemplary presentation program as described herein. Application command control may be provided for applications executing on a computing device such as mobile computing device 200. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 2A, one example of a mobile computing device 200 for implementing the examples is illustrated. In a basic configuration, the mobile computing device 200 is a handheld computer having both input elements and output elements. The mobile computing device 200 typically includes a display 205 and one or more input buttons 210 that allow the user to enter information into the mobile computing device 200. The display 205 of the mobile computing device 200 may also function as an input device (e.g., a touch screen display). If included, an optional side input element 215 allows further user input. The side input element 215 may be a rotary switch, a button, or any other type of manual input element. In alternative examples, mobile computing device 200 may incorporate more or less input elements. For example, the display 205 may not be a touch screen in some examples. In yet another alternative example, the mobile computing device 200 is a portable phone system, such as a cellular phone. The mobile computing device 200 may also include an optional keypad 235. Optional keypad 235 may be a physical keypad or a “soft” keypad generated on the touch screen display or any other soft input panel (SIP). In various examples, the output elements include the display 205 for showing a GUI, a visual indicator 220 (e.g., a light emitting diode), and/or an audio transducer 225 (e.g., a speaker). In some examples, the mobile computing device 200 incorporates a vibration transducer for providing the user with tactile feedback. In yet another example, the mobile computing device 200 incorporates input and/or output ports, such as an audio input (e.g., a microphone jack), an audio output (e.g., a headphone jack), and a video output (e.g., a HDMI port) for sending signals to or receiving signals from an external device.

FIG. 2B is a block diagram illustrating the architecture of one example of a mobile computing device. That is, the mobile computing device 200 can incorporate a system (i.e., an architecture) 202 to implement some examples. In one examples, the system 202 is implemented as a “smart phone” capable of running one or more applications (e.g., browser, e-mail, calendaring, contact managers, messaging clients, games, and media clients/players). In some examples, the system 202 is integrated as a computing device, such as an integrated personal digital assistant (PDA), tablet and wireless phone.

One or more application programs 266 may be loaded into the memory 262 and run on or in association with the operating system 264. Examples of the application programs include phone dialer programs, e-mail programs, personal information management (PIM) programs, word processing programs, spreadsheet programs, Internet browser programs, messaging programs, presentation programs and so forth. The system 202 also includes a non-volatile storage area 268 within the memory 262. The non-volatile storage area 268 may be used to store persistent information that should not be lost if the system 202 is powered down. The application programs 266 may use and store information in the non-volatile storage area 268, such as e-mail or other messages used by an e-mail application, and the like. A synchronization application (not shown) also resides on the system 202 and is programmed to interact with a corresponding synchronization application resident on a host computer to keep the information stored in the non-volatile storage area 268 synchronized with corresponding information stored at the host computer. As should be appreciated, other applications may be loaded into the memory 262 and run on the mobile computing device (e.g. system 202) described herein.

The system 202 has a power supply 270, which may be implemented as one or more batteries. The power supply 270 might further include an external power source, such as an AC adapter or a powered docking cradle that supplements or recharges the batteries.

The system 202 may include peripheral device port 230 that performs the function of facilitating connectivity between system 202 and one or more peripheral devices. Transmissions to and from the peripheral device port 230 are conducted under control of the operating system (OS) 264. In other words, communications received by the peripheral device port 230 may be disseminated to the application programs 266 via the operating system 264, and vice versa.

The system 202 may also include a radio interface layer 272 that performs the function of transmitting and receiving radio frequency communications. The radio interface layer 272 facilitates wireless connectivity between the system 202 and the “outside world,” via a communications carrier or service provider. Transmissions to and from the radio interface layer 272 are conducted under control of the operating system 264. In other words, communications received by the radio interface layer 272 may be disseminated to the application programs 266 via the operating system 264, and vice versa.

The visual indicator 220 may be used to provide visual notifications, and/or an audio interface 274 may be used for producing audible notifications via the audio transducer 225 (as described in the description of mobile computing device 200). In the illustrated example, the visual indicator 220 is a light emitting diode (LED) and the audio transducer 225 is a speaker. These devices may be directly coupled to the power supply 270 so that when activated, they remain on for a duration dictated by the notification mechanism even though the processor 260 and other components might shut down for conserving battery power. The LED may be programmed to remain on indefinitely until the user takes action to indicate the powered-on status of the device. The audio interface 274 is used to provide audible signals to and receive audible signals from the user. For example, in addition to being coupled to the audio transducer 225 (shown in FIG. 2A), the audio interface 274 may also be coupled to a microphone to receive audible input, such as to facilitate a telephone conversation. In accordance with examples of the present invention, the microphone may also serve as an audio sensor to facilitate control of notifications, as will be described below. The system 202 may further include a video interface 276 that enables an operation of an on-board camera 230 to record still images, video stream, and the like.

A mobile computing device 200 implementing the system 202 may have additional features or functionality. For example, the mobile computing device 200 may also include additional data storage devices (removable and/or non-removable) such as, magnetic disks, optical disks, or tape. Such additional storage is illustrated in FIG. 2B by the non-volatile storage area 268.

Data/information generated or captured by the mobile computing device 200 and stored via the system 202 may be stored locally on the mobile computing device 200, as described above, or the data may be stored on any number of storage media that may be accessed by the device via the radio 272 or via a wired connection between the mobile computing device 200 and a separate computing device associated with the mobile computing device 200, for example, a server computer in a distributed computing network, such as the Internet. As should be appreciated such data/information may be accessed via the mobile computing device 200 via the radio 272 or via a distributed computing network. Similarly, such data/information may be readily transferred between computing devices for storage and use according to well-known data/information transfer and storage means, including electronic mail and collaborative data/information sharing systems.

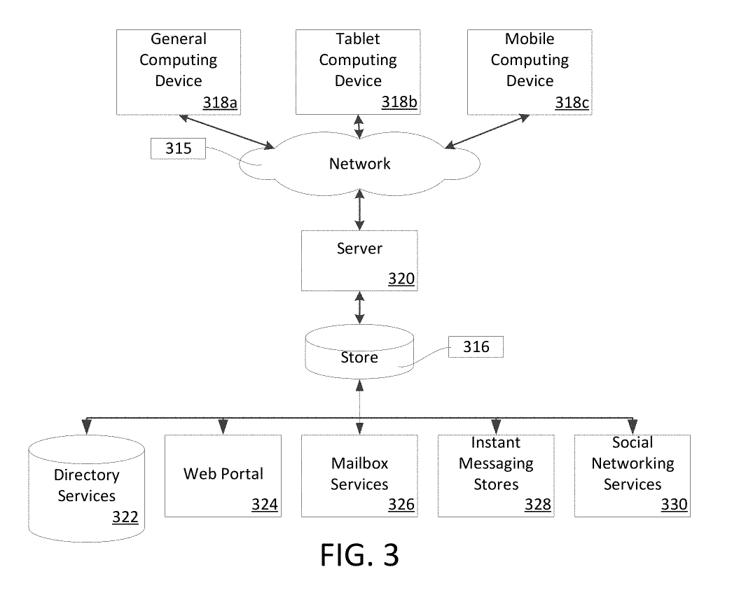

FIG. 3 illustrates one example of the architecture of a system for providing an application that reliably accesses target data on a storage system and handles communication failures to one or more client devices, as described above. The system of FIG. 3 may be an exemplary system configured for execution of an exemplary presentation program as described herein. Target data accessed, interacted with, or edited in association with programming modules 108 and/or applications 120 and storage/memory (described in FIG. 1) may be stored in different communication channels or other storage types. For example, various documents may be stored using a directory service 322, a web portal 324, a mailbox service 326, an instant messaging store 328, or a social networking site 330, application 128, IO manager 124, other utility 126, and storage systems may use any of these types of systems or the like for enabling data utilization, as described herein. A server 320 may provide storage system for use by a client operating on general computing device 102 and mobile device(s) 200 through network 315. By way of example, network 315 may comprise the Internet or any other type of local or wide area network, and a client node may be implemented for connecting to network 315. Examples of a client node comprise but are not limited to: a computing device 102 embodied in a personal computer, a tablet computing device, and/or by a mobile computing device 200 (e.g., mobile processing device). As an example, a client node may connect to the network 315 using a wireless network connection (e.g. WiFi connection, Bluetooth, etc.). However, examples described herein may also extend to connecting to network 315 via a hardwire connection. Any of these examples of the client computing device 102 or 200 may obtain content from the store 316.

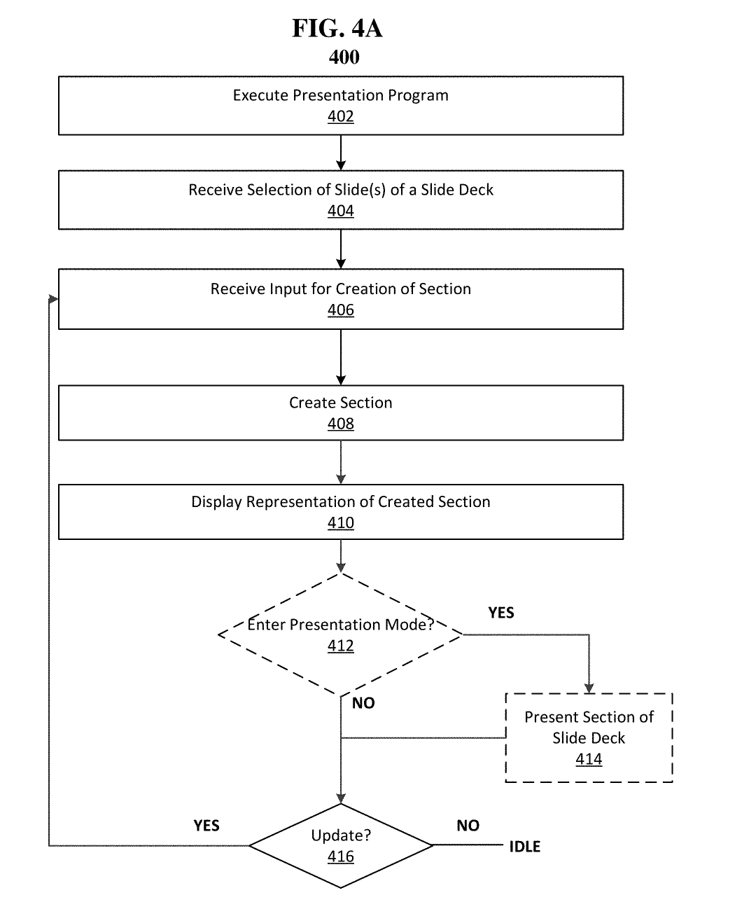

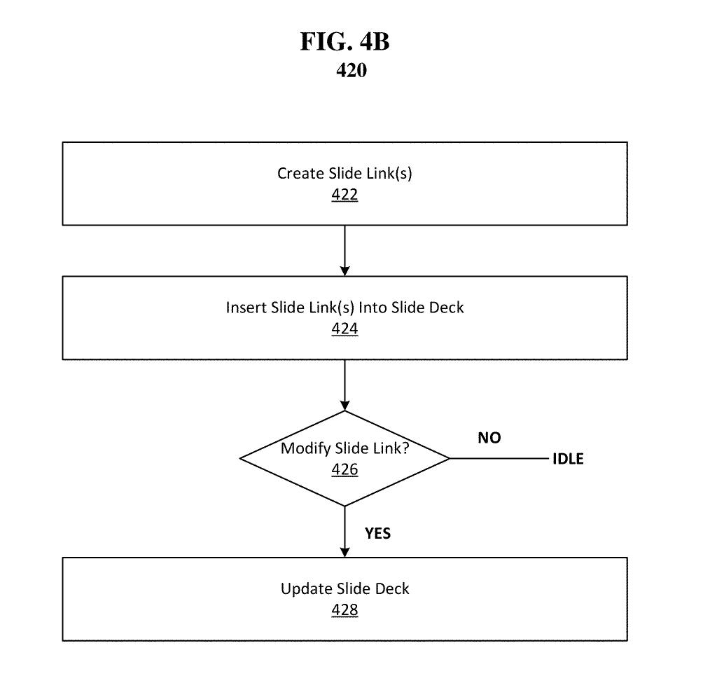

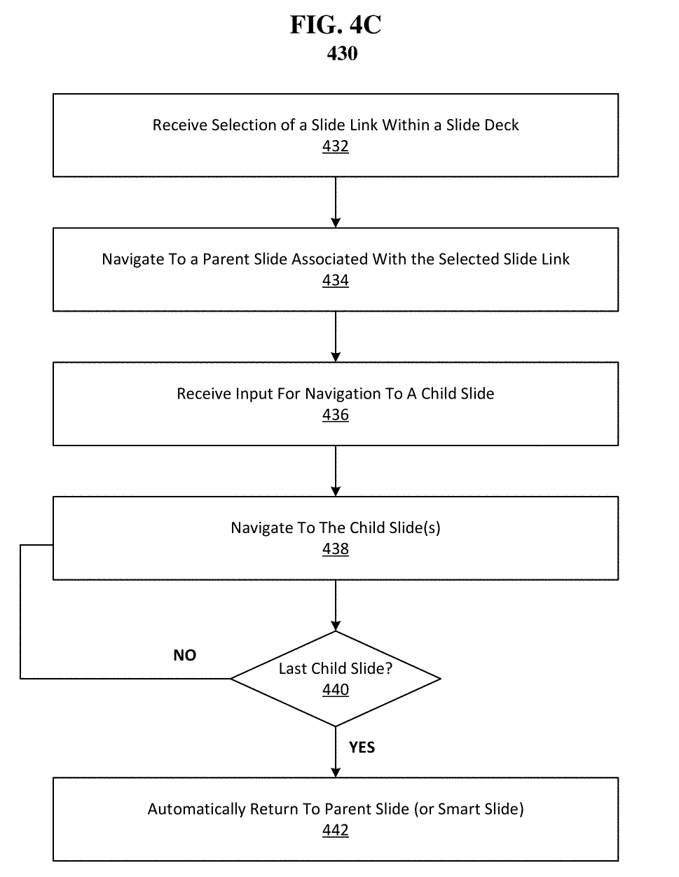

FIG. 4A is an exemplary method 400 related to creation of an exemplary section of slides, with which aspects of the present disclosure may be practiced. As an example, method 400 may be executed by an exemplary processing device and/or system such as those shown in FIGS. 1-3. In examples, method 400 may execute on a device comprising at least one processor configured to store and execute operations, programs or instructions. Operations performed in method 400 may correspond to operations executed by a system and/or service that execute computer programs, application programming interfaces (APIs), neural networks or machine-learning processing, among other examples. As an example, processing operations executed in method 400 may be performed by one or more hardware components. In another example, processing operations executed in method 400 may be performed by one or more software components. In some examples, processing operations described in method 400 may be executed by one or more applications/services associated with a web service that has access to a plurality of application/services, devices, knowledge resources, etc. For instance, an exemplary presentation program may be provided as a web-service (over a distributed network) that a user can access over a network such as the Internet. An exemplary presentation program may be executing on a processing device, for example, that executes method 400.

Method 400 begins at processing operation 402, where an exemplary presentation program is executed. As an example, a presentation program may be executed on a client processing device or a processing device associated with a distributed network (e.g. in examples where the presentation program is a web-service application). Presentation programs are software applications that allow end-users to create and view slide-based presentations. PowerPoint® from Microsoft®, Google® Slides, and Keynote® from Apple® are several examples of presentation programs that follow the slide-show model for presentations. Operation 402 may comprise providing an exemplary slide deck that a user may be building for a slide-based presentation.

An exemplary presentation program may be configured to provide assistant features for creation and management of an exemplary smart slide, slide link and/or section of slides, among other examples. At any point during execution (processing operation 402), the presentation program may be configured to offer user interface elements for assistance in creating exemplary smart slide, slide link and/or section of slides. As such functionality presents new features in a presentation program, a user interface of the presentation program may be configured to highlight such functionality for users. For instance, an indication may be provided that creation of a smart slide or slide link is an available feature, for example, through call-outs, highlighting, notifications, etc. Assistance for creation of a section and/or table of contents slide may further be provided through help features, videos, tutorials, etc.

At processing operation 404, selection of one or more slides of a slide deck may be received through the presentation program. Select slides may be used to create an exemplary section of slides, for example, that can be accessed through a slide link during a slide show presentation mode presenting a slide deck. Selection of slides may be made by a user and may occur in any manner including but not limited to: device input such as mouse selection or stylus, touch input and voice input, among other examples. In one example, a selection may be of one or more slides from a slide deck.

Flow may proceed to processing operation 406, where input is received for creation of a section of slides. As an example, a section of slides may be created for the one or more slides selected in processing operation 404. Processing operation 406 may create a section, from selected slides, based on a selection of a user interface element (e.g. application command control) for the presentation program or alternatively voice input and/or touch input, among other examples. For instance, an “insert” user interface element for creating a section may be selected.

At processing operation 408, the presentation program may create a section from the one or more selected slides. As an example, the section may be created (processing operation 408) based on receiving the input requesting creation of a section. Creation (operation 408) of a section may comprise grouping the selected slides in a parent/child relationship for the section of slides. For instance, a first slide (of the selected slides) may be assigned as the parent slide of the section with other selected slides being child slides of the parent. In an alternative example, child slides may be assigned to multiple parent slides. One skilled in the art that understands the present disclosure should recognize that the presentation program may be configured to manipulate or modify section creation, for example, based on any received user input. For instance, a user can modify an order of slides in a section to alter a parent/child relationship for a section of slides.

In some examples, the presentation program may be configured to create more than one section of slides. In one example, multiple sections may be created from selected slides based on input received from a user. In another example, the presentation program may be configured to create one section from the selected slides and create sections for any other slides that were not selected (e.g. non-selected slides may become their own section).

Flow may proceed to processing operation 410, where a representation of a created section may be displayed within the presentation program. For example, processing operation 410 may comprise displaying an updated slide deck (e.g. in an editing mode of the presentation program) that illustrates that the selected slides are grouped into a section. The presentation program may be configured to display (processing operation 410) the created section in an editing mode, where a user is able to edit slides/slide order of a slide deck. A user can choose to save or modify a slide deck. In one example, a user may select to view the slide deck in a slide show presentation mode of the presentation program. The slide show presentation mode may provide a presenter view of the slide deck, where the user has navigation control of the slide deck being presented in a slideshow presentation.

Flow may proceed to decision operation 412, where it is determined whether the slide show presentation mode is entered. If the slide show presentation mode is not entered, flow branches NO and processing of method 400 proceeds to decision operation 416 (described below). If input is received requesting entry of the slide show presentation mode, flow branches YES and method 400 proceeds to processing operation 414.

At processing operation 414, the presentation program enters the slide show presentation mode and presents the slide deck in a presenter view. In the presenter view, a user has navigation control of the slide deck being presented in a slideshow presentation. Presentation (processing operation 414) of the slide deck in the presenter view may comprise any navigation operation related to viewing slides of the slide deck including completing the slide deck and exiting a presenter view.

Flow may proceed to decision operation 416, where it is determined whether an update occurs to one or more sections of a slide deck. If no update occurs, flow branches NO and processing of method 400 remains idle until subsequent processing is received. If an update to one or more sections of the slide deck occurs (including creation of a new section), flow returns to processing operation 406, where input is received for creation (or update) of a section. As identified above, the presentation program may present the slide deck in an editing mode. Update (associated with decision operation 416) to one or more sections of the slide deck may occur while the slide deck is being presented in the editing mode (e.g. after exiting a presentation view of the slide deck).

FIG. 4B is an exemplary method 420 related to rendering an exemplary slide link, with which aspects of the present disclosure may be practiced. As an example, method 420 may be executed by an exemplary processing device and/or system such as those shown in FIGS. 1-3. In examples, method 420 may execute on a device comprising at least one processor configured to store and execute operations, programs or instructions. Operations performed in method 420 may correspond to operations executed by a system and/or service that execute computer programs, application programming interfaces (APIs), neural networks or machine-learning processing, among other examples. As an example, processing operations executed in method 420 may be performed by one or more hardware components. In another example, processing operations executed in method 420 may be performed by one or more software components. In some examples, processing operations described in method 420 may be executed by one or more applications/services associated with a web service that has access to a plurality of application/services, devices, knowledge resources, etc. For instance, an exemplary presentation program may be provided as a web-service (over a distributed network) that a user can access over a network such as the Internet. An exemplary presentation program may be executing on a processing device, for example, that executes method 420.

Method 420 begins at processing operation 422, where a slide link may be created. As an example, a slide link may be included in an exemplary smart slide, for example, to improve navigational functionality and associated processing during presentation of a slide deck. A smart slide is a slide of a slide deck that comprises one or more slide links, which provide an active link to another slide of the slide deck. Slide links can be created for individual slides or sections of slides. A slide may become a smart slide when one or more slide links are inserted within the slide. In examples, a slide link may be editable, where a user can manipulate content associated with the slide link as well as manipulate features of the slide link including but not limited to: placement, scale and orientation. In one example, an exemplary slide link may be a slide preview of one or more slides that may be navigated too based on selection of the slide link. A slide preview may be a pictorial representation of a slide but may comprise additional types of content including but not limited to rich text format, audio content, video content, hyperlinks, etc. The slide preview may incorporate content from one or more slides either in aggregation (e.g. section of slides) or as individual representations of the slides.

When a slide link is associated with a section of slides, rendering of the slide link may link a slide to a first slide (e.g. parent slide) of the section. An exemplary slide link can be positioned within a slide deck to provide direct access to a slide or a section of slides. In alternative examples, a slide link may be directly associated with a specific child slide of a section. Navigational control provided by an exemplary presentation program may vary depending on the type of slide link created. In some examples, processing operation 422 may comprise providing of user interface assistance for the creation of a slide link. Examples of user interface assistance have been previously provided in the description of method 400 (of FIG. 4A).

Flow may proceed to processing operation 424, where a slide link may be inserted into a slide deck. Insertion (processing operation 424) of an exemplary slide link may comprise creating a smart slide that is inserted as a new slide within a slide deck. In alternative examples, inserting (processing operation 424) of a slide link may comprise converting an existing slide into a smart slide by rendering the existing slide to include an active slide link. As described above, an exemplary smart slide may comprise one or more slide links. In one example, a smart slide may be a slide that is used to organize content of a slide deck, where the smart slide can be navigational tool for enhancing navigation of the slide deck. Examples for inserting a slide link may comprise but are not limited to: 1) selecting a user interface feature through an application command control of the user interface, 2) through dragging from thumbnail to a canvas of a slide (e.g. in an editing mode of the presentation program), and 3) converting an image picture or other content into a slide link.

An exemplary presentation program may be configured to enable actions such as: cutting, copying, and pasting of links and/or slides. In one example, copying and pasting a slide link preserves the linkage associated with the slide link. In that example, a destination slide where the slide link is pasted on may turn that destination slide into a parent slide of the slide link. The presentation program may further be configured to enable pasting a slide link to another productivity application. A result of a paste operation to another application may be an image of the copied content that can carry over the link information. Moreover, slide links copied to other productivity applications may auto-update similar to slide links within a presentation program.

The presentation program may further be configured to enable copying and pasting of exemplary smart slides. If a smart slide is copied and pasted, linkage and content of the smart slide remains actively enabled, for example, at a different slide location in a slide deck. Smart slides may also remain actively enabled in examples where a smart slide (and associated slides of any slide links) is copied and pasted to another slide deck. Developers of the presentation program may vary functionality related to adding or deleting of slide links and/or slides (e.g. smart slides, parent slides, child slides, etc.) including whether any of such links or slides is auto-updated based on particular actions or operations such as copying and pasting operations, among other examples.

Operation of method 420 may proceed to decision operation 426, where it is determined whether a request is received to modify an inserted slide link. If no request for slide link modification is received, flow branches NO and processing of method 420 remains idle until subsequent processing resumes. If a request for slide link modification is received, flow branches YES and proceeds to processing operation 428.

At processing operation 428, an exemplary slide deck may be updated. As an example, a slide link may be added, removed, modified, etc. For instance, a user may select to move a slide link to another slide. In that example, the presentation program may update the slide deck, for example, by updating one or more smart slides of a slide deck based on associated slide link modification. Slide links can be updated (e.g. dynamically) based on an update to a slide that is associated with a slide link. For instance, if content such as pictures or text changes, an updated slide link (or new slide link) can be automatically generated. In one example, slide links may be dynamically updated.

FIG. 4C is an exemplary method 430 related to execution of an exemplary presentation program, with which aspects of the present disclosure may be practiced. As an example, method 430 may be executed by an exemplary processing device and/or system such as those shown in FIGS. 1-3. In examples, method 430 may execute on a device comprising at least one processor configured to store and execute operations, programs or instructions. Operations performed in method 430 may correspond to operations executed by a system and/or service that execute computer programs, application programming interfaces (APIs), neural networks or machine-learning processing, among other examples. As an example, processing operations executed in method 430 may be performed by one or more hardware components. In another example, processing operations executed in method 430 may be performed by one or more software components. In some examples, processing operations described in method 430 may be executed by one or more applications/services associated with a web service that has access to a plurality of application/services, devices, knowledge resources, etc. For instance, an exemplary presentation program may be provided as a web-service (over a distributed network) that a user can access over a network such as the Internet. An exemplary presentation program may be executing on a processing device, for example, that executes method 430.

Method 430 begins at processing operation 432, where a selection of an exemplary slide link is received. In one example, processing operation 432 may receive a selection of a slide link while a slide deck is being presented in a slide show presentation mode of a presentation program. However, selection of a slide link may occur in any mode of the presentation program. Methods of selecting a slide may vary and are known to one skilled in the field of art. In examples where the presentation program is in an editing mode, alternative examples of method 430 may further comprise: receiving a request to enter the slide show presentation mode; and presenting the slide deck in the slide show presentation mode based on the received request. As described previously, features associated with a slide link may be editable. For example, a user may utilize the presentation program to manipulate placement of the slide link, scale of the slide link and/or orientation of the slide link. The presentation program may utilize such information to create a contextual zoom transition to or from a smart slide based on selection of a slide link. Examples of contextual zoom transitions are subsequently described.

Flow may proceed to processing operation 434, where a presentation program may navigate to a slide associated with a slide link. As an example, the presentation program may navigate to a first slide (e.g. parent slide of an exemplary section of slides) associated with a slide link. However, in other examples, a slide link may connect a smart slide to a single other slide. In some examples, the navigating may comprise non-linear navigation of slides out of an original slide order of the slide deck. For instance, an exemplary presentation program may process the selection of the slide link to skip out of an original slide order of the slide deck for rendering of a slide associated with the slide link. In examples, where the slide link is associated with a section of slides, the section of slides may comprise a parent slide and one or more child slides that are associated with the parent slide. However, the use of slide links is not restricted to such an example. Slide links may be used to associate child slides with multiple parent slides.

Selection (processing operation 434) of a slide link (of an exemplary smart slide) may cause the presentation program to execute a contextual zoom transition between the smart slide and a linked slide. A contextual zoom provides a view of content for the slide that is next to be viewed in a manner that relates to the slide that is currently being viewed.

In one example, a contextual zoom transition may be dynamic to account for manipulation of an exemplary slide link. For instance, a zoom-in transition may be generated for a transition between a smart slide and a first slide of a section. The zoom-in transition may account for features of the slide link including: a placement, a scale and an orientation of the slide link of the smart slide. For instance, a slide link may be located in an upper left corner of the smart slide, scaled to be larger than other content of the slide and oriented at an angle where the text of the slide link is rotated to be in a vertical alignment. In that example, a zoom-in transition may initiate a zoom from the perspective of the selected slide link where the transition: is initiated from the left side of the smart slide, enlarges the text of the slide link and rotates a canvas displaying the slide from an orientation of the text of the slide link to an orientation that matches the content of the first slide of the section. This is just one of many possible examples that illustrates how a zoom transition for a slide link is more dynamic than that of a standard zoom transition between slides. Standard zoom transitions typically only allow zooming from a center of a slide inward, where timing is the only adjustable parameter for standard transitions. Improved zoom transition functionality can be applied to any slide transition scenario including zoom-out transitions (e.g. from a section to a smart slide) and/or transitions between slides of a section or between smart slides, among other examples.

In another example of contextual zoom transitions, the presentation program may be configured to apply a contextual zoom transition that appears to seamlessly move to another slide so a user does not feel like the presentation program is moving to another slide. For instance, a contextual zoom transition of this nature may be programmed to occur when a user is transitioning between slides of a section (e.g. parent slide to/from child slide or child slide to/from child slide). In that example, a zoom transition may adopt a background of a parent slide of a section and maintain that background as navigation proceeds through other slides (e.g. child slides) of the section.

To generate a contextual zoom transition, the presentation program may create and utilize a data object for slide transition between slides. In doing so, the presentation program may utilize the data object to manage parameters associated with different slides to create transitions between slides. An exemplary data object may hold parameters related to slide transitions. Examples of parameters for slide transitions comprise but are not limited to: identification of slides to transition to (or transition from), parameters for layout of a slide, parameters for content of a slide, slide linking markers indicating sections, parent/child relationships between sections of slides and/or relationships of a slide link, dependency, etc., parameters for removing a background of a slide (for transition), parameters for adopting a background of a slide (for transition), parameters for inserting user interface elements for navigational control within a slide, parameters for features (e.g. placement, scale, orientation, etc.) associated with a created link such as a slide link and an indication as to whether to return to a previous slide or smart slide, among other examples. An exemplary presentation program may utilize a data object for slide transitions to generate a contextual zoom transition between a smart slide and a parent slide associated with a slide link.

In an example where a slide link is associated with a section of slides, flow may proceed to processing operation 436, where input is received for navigation to a child slide of the section. Methods of providing and/or receiving input may vary and are known to one skilled in the field of art.

Flow may proceed to processing operation 438, wherein the presentation program may navigate a slide deck to the child slide, for example, based on receiving input requesting navigation to the child slide. As described above, a section of slides may comprise a plurality of slides in a parent/child relationship for the section. Navigation between a parent slide and a child slide and/or between a child slide and another child slide may comprise executing contextual zoom transitions between slides. In an example where a slide transition is to occur from a parent slide of a section to a child slide of a section, the presentation program may be configured to execute a contextual zoom-in transition that maintains the background of the parent slide and displays content of the one or more child slides to create a seamless viewing experience during slide transition.

In examples where multiple child slides are included within a section, flow may proceed to decision operation 440, where it is determined whether a last child slide has been viewed when a request is received to move to a next slide. If there are still child slides within the section to access, flow may branch NO and return to processing operation 438, where the presentation program may navigate to an additional child slide based a request to move to a next slide. If the section is complete (e.g. last child slide has been viewed) upon a request to move to a next slide, flow branches YES and processing proceeds to processing operation 442.

At processing operation 442, the presentation program is configured to automatically return back to a first slide of a section (e.g. the parent slide of the section) based upon navigational completion of the one or more child slides of the section. Returning (processing operation 442) further comprises rendering a contextual zoom-out transition when transitioning from the one or more child slides back to the parent slide. In one example, an exemplary contextual zoom-out transition may account for the features of slide link, which is utilized to access a section of slides of a slide deck. A contextual zoom-out transition may account for features of the slide link including: a placement, a scale and an orientation of the slide link of a smart slide. For instance, the presentation program, when executing, a zoom-out transition, may be configured to execute a reverse processing from that of a zoom-in transition to return back to a smart slide from another slide (e.g. linked by the slide link).

In one example, the presentation program may keep track of accessed slides through a stack process operation. For example, the presentation program may utilize markers that can assist the presentation program with navigating a slide deck. In other examples where the presentation program is configured to return navigation to the parent slide, a user interface element may be presented on the parent slide (when returning back to the parent slide) to enable a user to easily transition back to the original smart slide. For instance, upon a return back to the parent slide, the presentation program may be configured to detect an action selected from one or more of a group consisting of: a mouse movement and touch input. Based on detection of an exemplary action, a user interface element for returning to the smart slide may be displayed.

In alternative examples, completion of a section of slides may result in an automatic return back to an original smart slide (from which a slide link was selected). An exemplary presentation program may be configured to enable users to define rules for customized navigational control of a slide deck. In some examples, the presentation program may interface with other types of application services to assist with processing for defining and applying rules that can be utilized by the presentation program.

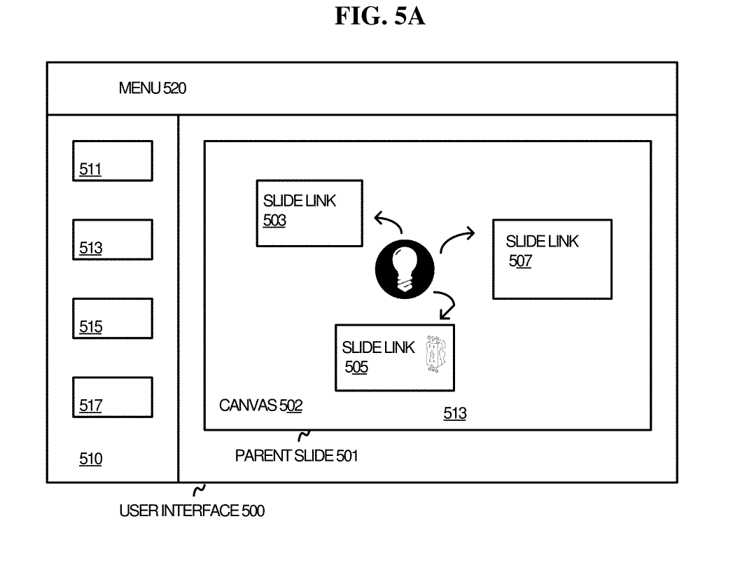

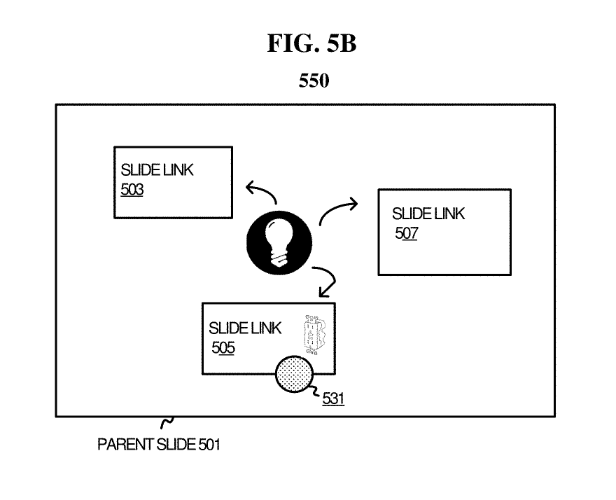

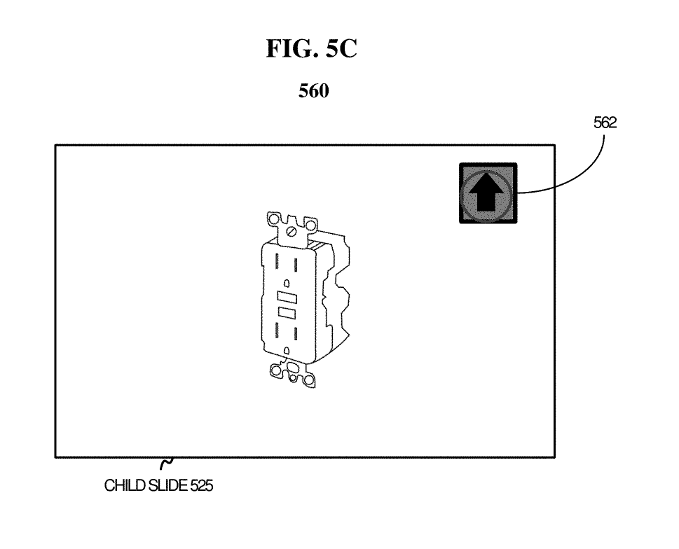

FIGS. 5A-5C provide exemplary user interface views for an exemplary presentation program, with which aspects of the present disclosure may be practiced.

FIG. 5A illustrates a slide presentation in editing mode of a presentation program. User interface 501 is a user interface to a presentation program. User interface 501 includes a parent slide 501, which is a smart slide as contemplated herein. A smart slide is a slide of a slide deck that comprises one or more slide links. As described above, a slide link provides direct access to another slide (of the slide deck) or a group of slides (e.g. section) of the slide deck. User interface 501 also includes preview panel 510 and menu 520. Preview panel 510 provides a preview of the individual slides in a presentation, including preview 511, preview 513, preview 515, and preview 517. Preview 511 is a preview of parent slide 501, while the other previews are previews of other slides (not shown). Parent slide 501 includes a canvas 502 on which a slide may be designed and edited. In this example illustration, three slide links have been placed on the canvas, represented by slide link 503, slide link 505, and slide link 507. The slide links are each linked to an individual slide. When in presentation mode, selecting one of the slide links causes a visual transition to its associated slide.

FIG. 5B illustrates user interface view 550. In user interface view 550, parent slide 501 is presented in an exemplary slide show presentation mode. When a selection 531 is made of slide link 505, a contextual zoom-in transition brings the user interface to a view of its associated slide, represented by slide 525 in user interface view 560 (FIG. 5C).

Moreover, user interface view 560 of FIG. 5C illustrates that a child slide may comprise a just-in-time navigation feature 562 that enables navigation back to a parent slide of a section. While the just-in-time navigation feature 562 is shown at the right-side of a displayed screen, a position of the just-in-time navigation feature 562 may vary based on developer specifications. The just-in-time navigation feature 562 may be selectively displayed whenever a child slide is displayed within a section, among other examples. In some examples, the just-in-time navigation feature 562 may be selectively displayed, where the just-in-time navigation feature 562 is hidden until the user moves the mouse and/or taps on the screen. In such an example, when the on screen user interface controls disappear, the just-in-time navigation feature 562 may disappear as well.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

1. A method comprising:
receiving, during a slide show presentation mode that is presenting a slide deck comprising a plurality of slides, a selection of slide link within a slide of the slide deck;
navigating to a parent slide, of a section of slides, that is associated with a selected slide link, wherein the section of slides comprises the parent slide and one or more child slides associated with the parent slide;
receiving input to navigate to the one or more child slides;
navigating to the one or more child slides based on the received input; and
automatically returning, in the slide show presentation mode, back to the parent slide based upon navigational completion of the one or more child slides of the section.

2. The method of claim 1, wherein the navigating to the parent slide comprises controlling the slide deck to skip out of an original slide order of the slide deck to navigate to the parent slide based on the selection of the slide link.

3. The method of claim 2, wherein the navigation to the parent slide further comprises rendering a contextual zoom-in transition from the slide to the parent slide, and wherein the contextual zoom-in transition accounts for a placement, a scale and an orientation of the slide link within the slide when transitioning to the parent slide.

4. The method of claim 1, further comprising receiving a request to navigate from the parent slide to a first child slide of the one or more child slides, and navigating to the first child slide based on the received request, wherein the navigating to the first child slide comprises rendering a contextual zoom-in transition that maintains the background of the parent slide and display content of the first child slide when transitioning to the first child slide.

5. The method of claim 4, further comprising receiving a request to navigate from the first child slide, of the one or more child slides, to a second child slide of the one or more child slides; and navigating to the second child slide based on the received request, wherein the navigating from the first child slide to the second child slide further comprises rendering a contextual zoom-in transition that maintains the background of the parent slide and modifies displayed content to reflect content of the second child slide when transitioning to the second child slide.

6. The method of claim 5, wherein the automatically returning back to the parent slide further comprises rendering a contextual zoom-out transition from the second child slide that maintains the background of the parent slide and modifies displayed content to reflect content of the parent slide when transitioning to the parent slide.

7. The method of claim 5, further comprising detecting an action selected from one or more of a group consisting of: a mouse movement and touch input; and displaying, within the second child slide, a user interface element for returning to the parent slide based on a detection of the action.

8. The method of claim 1, further comprising detecting an action selected from one or more of a group consisting of: a mouse movement and touch input; and displaying, within the parent slide, a user interface element for returning to a previous slide of the slide deck based on a detection of the action.

9. The method of claim 1, further comprising receiving a request to return to the slide with the slide link, and returning navigation of the slide deck to the slide, wherein the returning further comprises rendering a contextual zoom-out transition that accounts for a placement, a scale and an orientation of the slide link when transitioning back to the slide.

10. The method of claim 1, further comprising receiving a request to enter the slide show presentation mode; and presenting the slide deck in the slide show presentation mode based on the received request.

11. A method comprising:
rendering a parent slide in a user interface of a presentation program, wherein the parent slide is linked to one or more child slides within a slide deck of the presentation program;
in response to a selection of a child slide from the one or more child slides, rendering a contextual zoom-in transition from the parent slide to the child slide; and
in response to navigational completion of the child slide, automatically rendering a contextual zoom-out transition from the child slide back to the parent slide.

12. The method of claim 11, wherein the contextual zoom-in transition maintains the background of the parent slide and displays content of the child slide to create a seamless viewing experience during slide transition.

13. The method of claim 11, further comprising receiving a request to enter a slide show presentation mode; and presenting the slide deck in the slide show presentation mode based on the received request.

14. The method of claim 13, wherein the rendering renders the parent slide in the slide show presentation mode.

15. The method of claim 11, further comprising receiving a request to navigate from the child slide to a second child slide of the one or more child slides; and navigating to the second child slide based on the received request, wherein the navigating to the second child slide further comprises rendering a contextual zoom-in transition for the second child slide that maintains a background of the parent slide and modifies displayed content to reflect the content of the second child slide.

16. The method of claim 11, further comprising receiving a selection of a slide link within a slide, wherein the rendering of the parent slide occurs based on the selection of the slide link, and wherein the rendering of the parent slide further comprises rendering a contextual zoom-in transition that accounts for a placement, a scale and an orientation of the slide link when transitioning to the parent slide.

17. A system comprising:
at least one processor; and
a memory operatively connected with the at least one processor storing computer-executable instructions that, when executed by the at least one processor, causes the at least one processor to execute a method that comprises:
rendering a parent slide in a user interface of a presentation program, wherein the parent slide is linked to one or more child slides within a slide deck of the presentation program,
in response to a selection of a child slide from the one or more child slides, rendering a contextual zoom-in transition from the parent slide to the child slide, and
in response to navigational completion of the child slide, automatically rendering a contextual zoom-out transition from the child slide back to the parent slide.

18. The system of claim 17, wherein the contextual zoom-in transition maintains the background of the parent slide and displays content of the child slide to create a seamless viewing experience during slide transition.

19. The system of claim 17, wherein the executed method further comprises: receiving a request to enter a slide show presentation mode, and presenting the slide deck in the slide show presentation mode based on the received request.

20. The system of claim 19, wherein the executed method further comprises: receiving a selection of a slide link within a slide, wherein the rendering of the parent slide occurs based on the selection of the slide link, and wherein the rendering of the parent slide further comprises rendering a contextual zoom-in transition that accounts for a placement, a scale and an orientation of the slide link when transitioning to the parent slide.

21. (canceled)
